(19) United States
(12) Patent Application Publication
(10) Pub. No.: US 2025/0203023 A1
(43) Pub. Date: Jun. 19, 2025

(54) WALL MOUNTING DEVICE FOR MOUNTING A SCANNER

(71) Applicant: Foxlink Image Technology Co., Ltd., New Taipei City (TW)

(72) Inventors: Wen Chu Liao, New Taipei City (TW); Yun Long Lai, New Taipei City (TW); Chi Cheng Chuang, New Taipei City (TW)

(21) Appl. No.: 18/771,124

(22) Filed: Jul. 12, 2024

(30) Foreign Application Priority Data
Dec. 14, 2023 (CN) 202323424399.X

(51) Int. Cl. H04N 1/00

(52) U.S. Cl. CPC H04N 1/00562; H04N 1/00551

(57) ABSTRACT

A wall mounting device for mounting a scanner includes a bracket, a fastening element, a guiding element and a paper outlet tray. The scanner defines an inputting end and an outputting end. A lower end of the bracket has a scanner holder. An upper end of the scanner holder is opened freely to form an assembling hole. A lower end of the scanner holder defines an opening groove. The inputting end is exposed to the assembling hole. The outputting end is exposed to the opening groove. The fastening element is fastened to the bracket. The guiding element is mounted to the upper end of the scanner holder. The inputting end is corresponding to the guiding element through the assembling hole. The paper outlet tray is mounted to the lower end of the bracket. The outputting end is corresponding to the paper outlet tray through the opening groove.

### CROSS REFERENCE TO RELATED APPLICATIONS

The present application is based on, and claims priority from, China Patent Application No. 202323424399.X, filed Dec. 14, 2023, the disclosure of which is hereby incorporated by reference herein in its entirety.

### BACKGROUND OF THE INVENTION

### Field of the Invention

The present invention generally relates to a wall mounting device, and more particularly to a space-saving wall mounting device for mounting a scanner.

### Description of Related Art

Generally, a scanner is a digital device which is used to convert traditional paper documents into digitalized electronic files. Compare the traditional paper documents with the digitalized electronic files, the digitalized electronic files are more beneficial for an edition, a storage and transmission. With the increasing popularity of a file digitization conception, that the traditional paper documents are digitalized through the scanner has become a preferred choice for a modern file management.

Referring to FIG. 18, a conventional scanner 1′ is shown. The conventional scanner 1′ is placed on a desktop, and two ends of the conventional scanner 1′ have an inputting end 11′ and an outputting end 12′. A user may feed a document A′ which is to be scanned into the conventional scanner 1′ from the inputting end 11′, and then the document A′ is fed out from the outputting end 12′ to complete a scanning process of the document A′. Because other sundries, such as electrical appliances, are stacked on the desktop, a desktop space which is adjacent to the inputting end 11′ and a desktop space which is adjacent to the outputting end 12′ are blocked by the sundries. Before scanning the document A′, enough space on the desktop should be vacated. When the document A′ is in the scanning process, the document A′ is prevented from being interfered by the sundries.

However, large electrical appliances which are commonly used are screens, computer hosts, sound boxes, etc. The large electrical appliances are placed on the desktop, and the large electrical appliances are inconvenient to be removed to adjust the desktop space.

Therefore, it is necessary to provide a space-saving wall mounting device for mounting a scanner to effectively solve a dilemma of an insufficient desktop space.

### BRIEF SUMMARY OF THE INVENTION

An object of the present invention is to provide a space-saving wall mounting device for mounting a scanner to effectively solve a dilemma of an insufficient desktop space. The wall mounting device for mounting the scanner is fastened to an object. The object is made of a ferromagnetic material. A top end and a bottom end of the scanner define an inputting end and an outputting end, respectively. The wall mounting device for mounting the scanner includes a bracket, a fastening element, a hollow guiding element and a paper outlet tray. A lower end of the bracket has a scanner holder. The scanner holder has a bottom wall, two front walls bent upward from two sides of a front of the bottom wall, and two side walls bent upward from two opposite sides of the bottom wall. The two front walls, the bottom wall and the two side walls surround a mounting space. An upper end of the scanner holder is opened freely to form an assembling hole connected with the mounting space. The scanner is inserted into the mounting space from the assembling hole. A lower end of the scanner holder defines an opening groove, and the opening groove penetrates through a front end of the bottom wall. The inputting end is corresponding to the assembling hole. The inputting end is exposed to the assembling hole. The outputting end is corresponding to the opening groove. The outputting end is exposed to the opening groove. The fastening element is fastened to a rear surface of the bracket. The fastening element includes a magnetic part. The magnetic part is arranged at the rear surface of the bracket. The object is mutually attracted with the magnetic part, so the scanner holder of the bracket together with the scanner is fastened to the object. The hollow guiding element is mounted to the upper end of the scanner holder of the bracket. The guiding element is corresponding to the assembling hole of the scanner holder. The inputting end is corresponding to the guiding element through the assembling hole. The paper outlet tray is mounted to the lower end of the bracket. The paper outlet tray is corresponding to the opening groove of the scanner holder. The outputting end is corresponding to the paper outlet tray through the opening groove.

Another object of the present invention is to provide a wall mounting device for mounting a scanner, the wall mounting device for mounting the scanner being fastened to an object, a top end and a bottom end of the scanner defining an inputting end and an outputting end, respectively, the wall mounting device for mounting the scanner comprising: a bracket, a lower end of the bracket having a scanner holder, the scanner holder having a bottom wall, a front wall bent upward from a front of the bottom wall, and two side walls bent upward from two opposite sides of the bottom wall, the front wall, the bottom wall and the two side walls surrounding a mounting space, an upper end of the scanner holder being opened freely to form an assembling hole connected with the mounting space, the scanner being inserted into the mounting space from the assembling hole, a lower end of the scanner holder defining an opening groove, and the opening groove penetrating through the bottom wall, the inputting end being corresponding to the assembling hole, the inputting end being exposed to the assembling hole, the outputting end being corresponding to the opening groove, the outputting end being exposed to the opening groove; a fastening element mounted to the bracket for fastening the bracket to the object; a guiding element mounted to the upper end of the scanner holder of the bracket, the guiding element being corresponding to the assembling hole of the scanner holder, the inputting end being corresponding to the guiding element through the assembling hole; and a paper outlet tray mounted to the lower end of the bracket, the paper outlet tray being corresponding to the opening groove of the scanner holder, the outputting end being corresponding to the paper outlet tray through the opening groove, wherein two sides of an upper end of the paper outlet tray are pivotally connected to two sides of the lower end of the bracket, the paper outlet tray is rotatable with respect to the bracket, and the paper outlet tray is foldable with respect to the bracket.

Another object of the present invention is to provide a wall mounting device for mounting a scanner, the wall mounting device for mounting the scanner being fastened to an object, a top end and a bottom end of the scanner defining an inputting end and an outputting end, respectively, the wall mounting device for mounting the scanner comprising: a bracket, a lower end of the bracket having a scanner holder, the scanner holder being detachably mounted to the bracket, the scanner holder having a mounting space formed therein, an upper end of the scanner holder being opened freely to form an assembling hole connected with the mounting space, the scanner being inserted into the mounting space from the assembling hole, a lower end of the scanner holder defining an opening groove, and the opening groove connected with the mounting space, the inputting end being corresponding to the assembling hole, the inputting end being exposed to the assembling hole, the outputting end being corresponding to the opening groove, the outputting end being exposed to the opening groove; a fastening element mounted to the bracket for fastening the bracket to the object; a guiding element mounted to the upper end of the scanner holder of the bracket, the guiding element being corresponding to the assembling hole of the scanner holder, the inputting end being corresponding to the guiding element through the assembling hole, a middle of the guiding element having a guiding slot vertically penetrating through a top and a bottom of the guiding element, a guiding rib extending from one inner surface of the guiding slot, the other inner surface of the guiding slot being cut off to form an accommodating slot; and a paper outlet tray mounted to the lower end of the bracket, the paper outlet tray being corresponding to the opening groove of the scanner holder, the outputting end being corresponding to the paper outlet tray through the opening groove.

As described above, the scanner is used for scanning a document, the wall mounting device for mounting the scanner includes the bracket which has the scanner holder, the fastening element fastened to the bracket, and the guiding element and the paper outlet tray combined with the bracket. Furthermore, the guiding element is mounted at the upper end of the scanner holder and the guiding element is aligned with the inputting end of the scanner, the paper outlet tray is mounted at the lower end of the bracket and the paper outlet tray is aligned with the outputting end of the scanner, and the outputting end is disposed corresponding to the opening groove of the scanner holder. In addition, the paper outlet tray is able to be rotated and folded with respect to the bracket for maintaining a folded status and saving a space. Thus, the scanner is received in the scanner holder by the wall mounting device for mounting the scanner, the bracket of the wall mounting device for mounting the scanner is fastened on the object which is a wall or an office partition via the fastening element to proceed with a scanning, and the space-saving wall mounting device for mounting the scanner is provided to effectively solve a dilemma of an insufficient desktop space.

### BRIEF DESCRIPTION OF THE DRAWINGS

The present invention will be apparent to those skilled in the art by reading the following description, with reference to the attached drawings, in which:

FIG. 1 is a schematic diagram shows a wall mounting device for mounting a scanner, wherein the scanner is mounted to an object by the wall mounting device for mounting the scanner according to the present invention;

FIG. 2 is a perspective view of the wall mounting device for mounting the scanner according to a first preferred embodiment of the present invention;

FIG. 3 is another perspective view of the wall mounting device for mounting the scanner according to the first preferred embodiment of the present invention;

FIG. 4 is an exploded view of the wall mounting device for mounting the scanner according to the first preferred embodiment of the present invention;

FIG. 5 is a perspective view of a bracket of the wall mounting device for mounting the scanner according to the first preferred embodiment of the present invention;

FIG. 6 is a perspective view showing that a fastening element is fastened to the bracket of the wall mounting device for mounting the scanner according to the first preferred embodiment of the present invention;

FIG. 7 is a perspective view of a guiding element of the wall mounting device for mounting the scanner according to the present invention;

FIG. 8 is another perspective view of the guiding element of the wall mounting device for mounting the scanner according to the present invention;

FIG. 9 is a cross-sectional view of the guiding element of the wall mounting device for mounting the scanner along a line IX-IX of FIG. 8;

FIG. 10 is a perspective view of the wall mounting device for mounting the scanner according to a second preferred embodiment of the present invention;

FIG. 11 is an exploded view of the wall mounting device for mounting the scanner according to the second preferred embodiment of the present invention;

FIG. 12 is an exploded view showing the bracket and a scanner holder of the wall mounting device for mounting the scanner according to the second preferred embodiment of the present invention;

FIG. 13 is another exploded view showing the bracket and the scanner holder of the wall mounting device for mounting the scanner according to the second preferred embodiment of the present invention;

FIG. 14 is a schematic diagram of the wall mounting device for mounting the scanner, wherein a paper outlet tray of the wall mounting device for mounting the scanner is folded or unfolded according to the second preferred embodiment of the present invention;

FIG. 15 is a partially enlarged cross-sectional view of an encircled portion XV of the wall mounting device for mounting the scanner of FIG. 14;

FIG. 16 is a partial view of the bracket of the wall mounting device for mounting the scanner according to the second preferred embodiment of the present invention;

FIG. 17 is a partial view of the paper outlet tray of the wall mounting device for mounting the scanner according to the second preferred embodiment of the present invention; and

FIG. 18 is a schematic diagram shows a conventional scanner in prior art, wherein the conventional scanner is placed on a desktop.

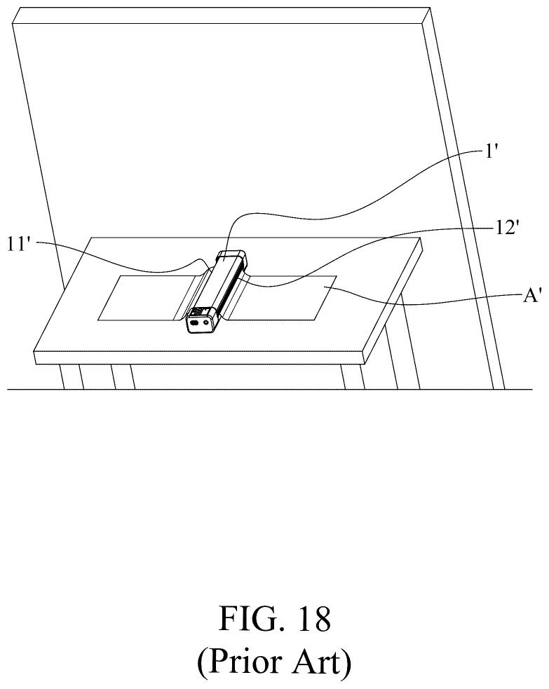

### DETAILED DESCRIPTION OF THE INVENTION

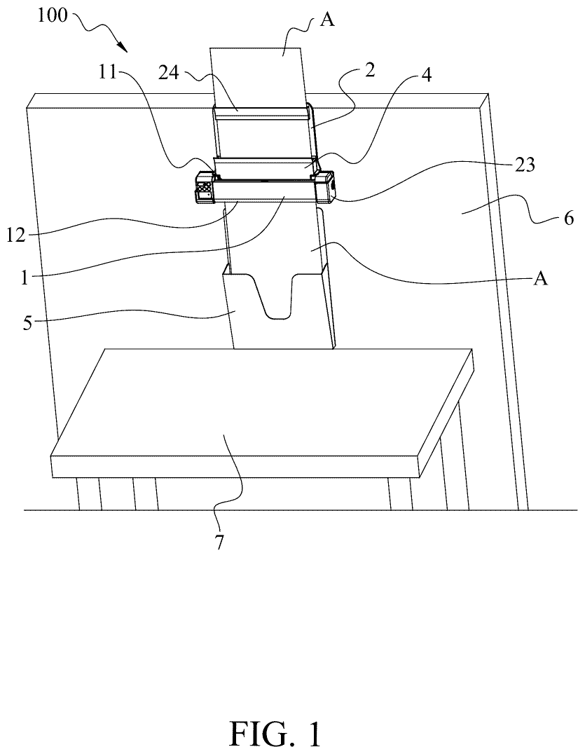

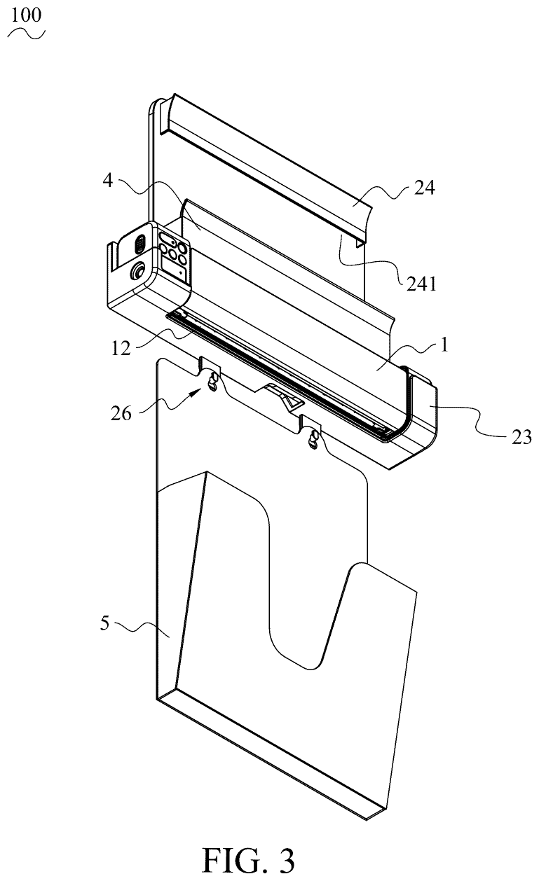

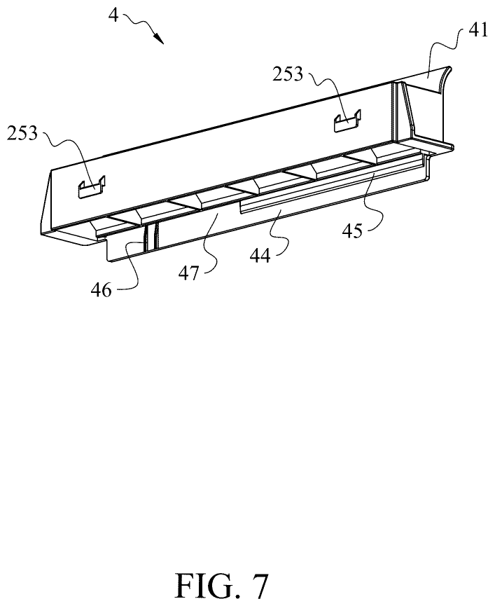

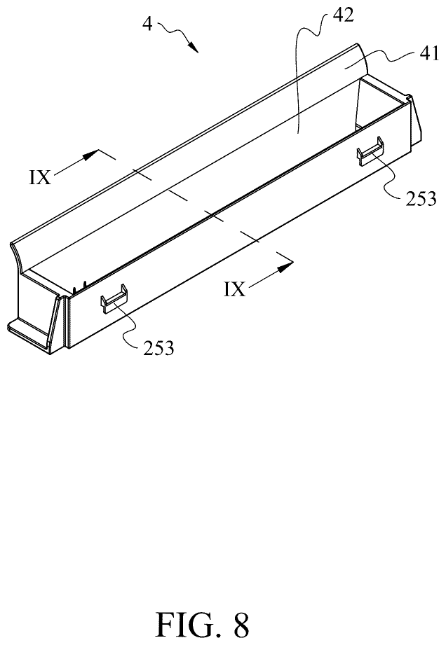

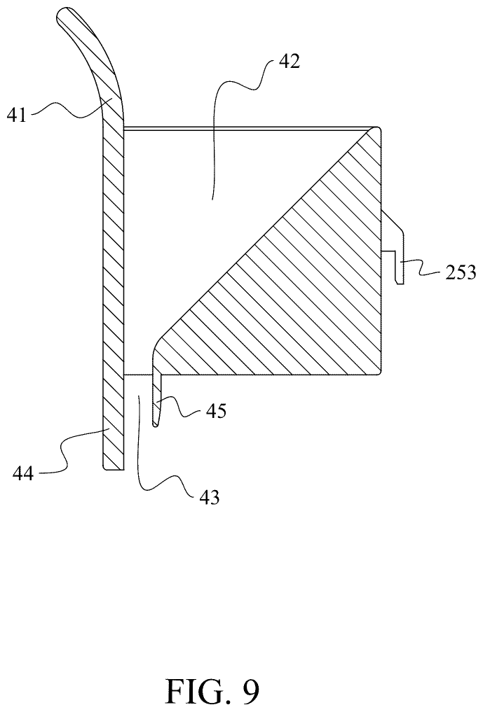

Referring to FIG. 1 to FIG. 10, a wall mounting device 100 for mounting a scanner 1 according to the present invention is shown. The wall mounting device 100 for mounting the scanner 1 is fastened to an object 6. The scanner 1 is used for scanning a document A. The wall mounting device 100 for mounting the scanner 1 includes a bracket 2, a fastening element 3 fastened to a rear surface of the bracket 2, a hollow guiding element 4 and a paper outlet tray 5. A lower end of the bracket 2 has a scanner holder 23 for holding the scanner 1. The hollow guiding element 4 is mounted to an upper end of the scanner holder 23 of the bracket 2, and the hollow guiding element 4 is corresponding to the upper end of the scanner holder 23 of the bracket 2. The paper outlet tray 5 is mounted to the lower end of the bracket 2, and the paper outlet tray 5 is corresponding to a lower end of the scanner holder 23 of the bracket 2. Specifically, the wall mounting device 100 for mounting the scanner 1 includes two fastening elements 3 fastened to the rear surface of the bracket 2.

Referring to FIG. 1 to FIG. 6, the scanner holder 23 is arranged for mounting the scanner 1, and the scanner holder 23 of the bracket 2 together with the scanner 1 is mounted to the object 6. The object 6 is disposed vertically on the ground, and the object 6 is perpendicular to a desktop 7. The object 6 is a wall or an office partition. The object 6 includes a structure (not shown). The structure of the object 6 is connectable to the fastening element 3 for fastening the bracket 2 on the object 6. The structure of the object 6 is corresponding to the fastening element 3. The structure of the object 6 is fastened with the fastening element 3.

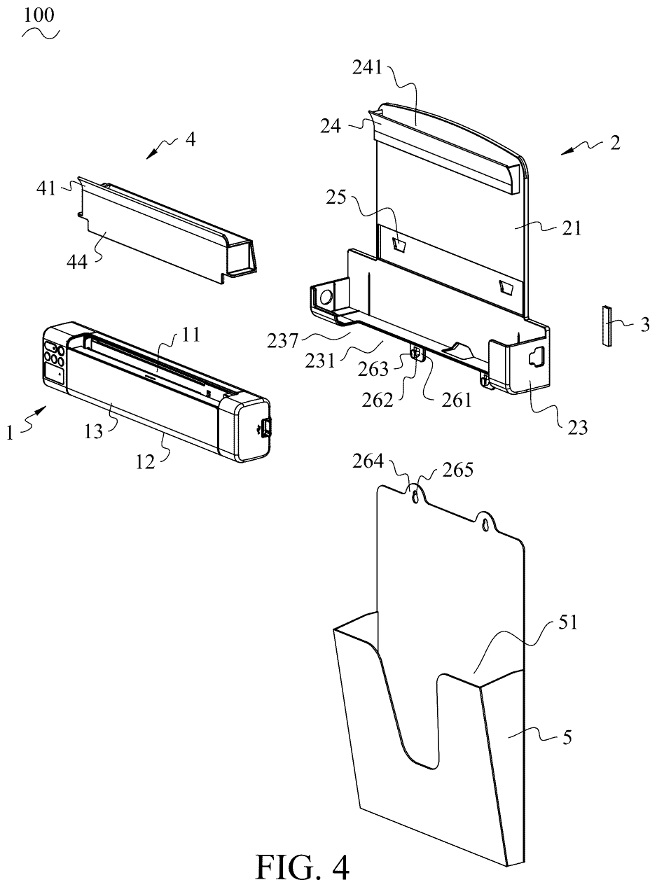

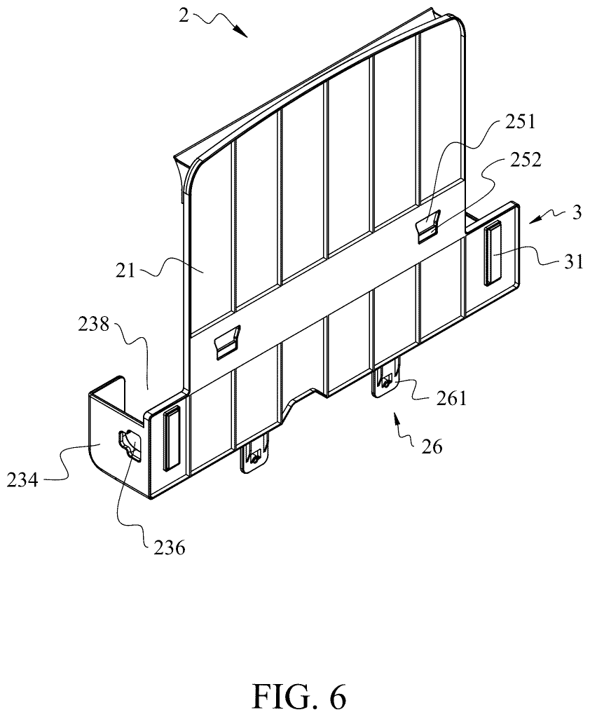

Referring to FIG. 1, FIG. 4 and FIG. 6, the wall mounting device 100 for mounting the scanner 1 according to a first preferred embodiment of the present invention is shown. The fastening element 3 includes a magnetic part 31. Specifically, each fastening element 3 includes the magnetic part 31. The magnetic part 31 is arranged at the rear surface of the bracket 2. The object 6 is made of a ferromagnetic material. The object 6 is mutually attracted with the magnetic part 31, so the scanner holder 23 of the bracket 2 together with the scanner 1 is fastened to the object 6.

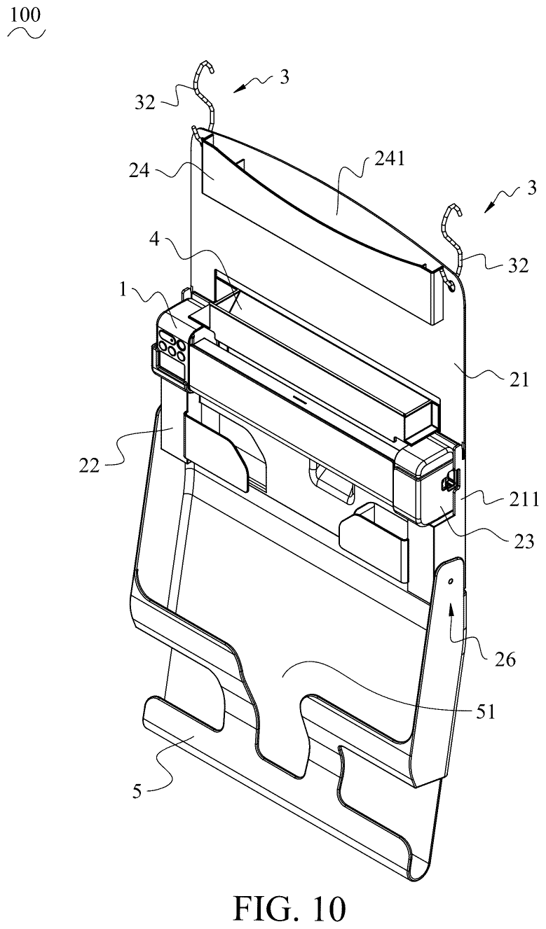

Referring to FIG. 1 and FIG. 10, the wall mounting device 100 for mounting the scanner 1 according to a second preferred embodiment of the present invention is shown. The fastening element 3 includes a S-shaped locking hook 32. The locking hook 32 is mounted to an upper end of the bracket 2. Specifically, each fastening element 3 includes the locking hook 32. The locking hook 32 penetrates through the upper end of the bracket 2. The object 6 is equipped with a transverse rod (not shown) for hanging the locking hook 32.

Referring to FIG. 1, FIG. 4, FIG. 6 and FIG. 10, in the first preferred embodiment, the bracket 2 is fastened to the object 6 by the magnetic part 31. In the second preferred embodiment, the bracket 2 is fastened to the object 6 via the locking hook 32. A method of fastening the bracket 2 to the object 6 is without being limited to this, the fastening element 3 is able to be optionally set as at least one or a combination of a suction cup, an adhesive, a screw, a rope suspension and so on. In the present invention, the wall mounting device 100 for mounting the scanner 1 effectively solves an insufficient desktop space problem by using the bracket 2 to fasten the scanner 1 to the object 6, and the object 6 is the wall or the office partition, so that a scanning is proceeded.

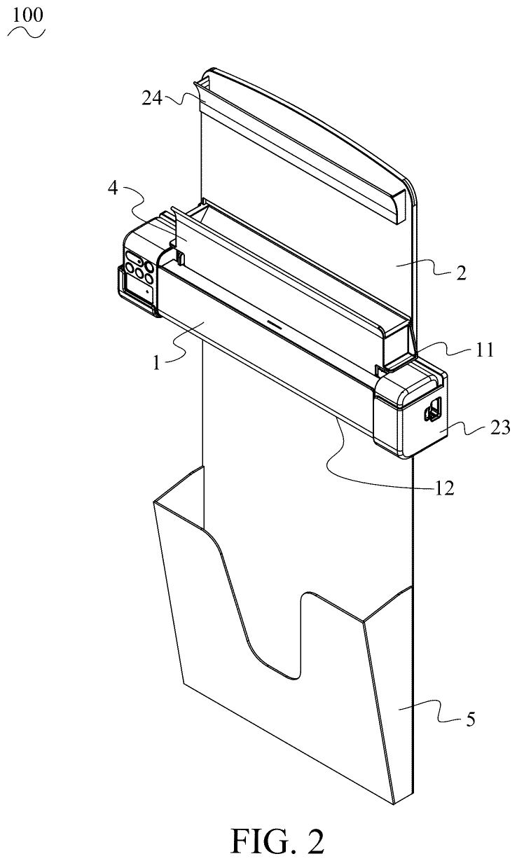

Referring to FIG. 2 to FIG. 6, in the first preferred embodiment, the scanner 1 is a portable automatic feeding scanner. A top end and a bottom end of the scanner 1 define an inputting end 11 and an outputting end 12, respectively. The inputting end 11 is aligned with the guiding element 4, and the inputting end 11 is connected to the guiding element 4. The outputting end 12 is aligned with the paper outlet tray 5. The bracket 2 includes a base plate 21, the scanner holder 23 and a hollow feed-in section 24. The wall mounting device 100 for mounting the scanner 1 further includes an upper assembly unit 25 and a lower assembly unit 26. The base plate 21 is attached to the object 6. The fastening element 3 is mounted at a rear surface of the base plate 21 for fastening the bracket 2 to the object 6. The scanner holder 23 is formed at a bottom end of the base plate 21. The scanner holder 23 is a hollow rectangular shape. The lower end of the scanner holder 23 defines an opening groove 231 penetrating through a bottom and a front of the scanner holder 23.

The scanner holder 23 has a bottom wall 233, two front walls 232 bent upward from two sides of a front of the bottom wall 233, and two side walls 234 bent upward from two opposite sides of the bottom wall 233. The two side walls 234 are arranged at two opposite sides of the scanner holder 23. The two front walls 232, the bottom wall 233 and the two side walls 234 surround a mounting space 238. The upper end of the scanner holder 23 is opened freely to form an assembling hole 239 connected with the mounting space 238. The scanner 1 is inserted downward into the mounting space 238 of the scanner holder 23 from the assembling hole 239. At least one of the two side walls 234 and the bottom wall 233 of the scanner holder 23 has an operating hole 236 penetrating through the at least one of the two side walls 234 and the bottom wall 233 of the scanner holder 23. Each of the two side walls 234 and the bottom wall 233 of the scanner holder 23 has the operating hole 236. The two operating holes 236 of the two side walls 234 transversely penetrate through the two side walls 234 of the scanner holder 23. The operating hole 236 of the bottom wall 233 vertically penetrates through the bottom wall 233 of the scanner holder 23. The operating holes 236 of the scanner holder 23 are corresponding to operating parts (not shown) of the scanner 1. When the scanner 1 is assembled in the scanner holder 23, a user is able to operate the operating parts of the scanner 1 through the operating holes 236 of the scanner holder 23.

Specifically, each operating part of the scanner 1 is able to be a button, a charging hole, a memory card slot, a display panel, a transmitting slot, or a combination of the button, the charging hole, the memory card slot, the display panel and the transmitting slot. A shape of each operating hole 236 is matched a shape of one operating part of the scanner 1. The opening groove 231 is formed to the bottom wall 233, and the opening groove 231 penetrates through a front end of the bottom wall 233. The two front walls 232 are spaced from each other. The scanner holder 23 has a maintaining hole 237 between the two front walls 232. The maintaining hole 237 is corresponding to a movable cover 13 of the scanner 1, so when the scanner 1 causes a breakdown, such as a paper jam, the user is able to operate the movable cover 13 of the scanner 1 via the maintaining hole 237 to troubleshoot the breakdown.

When the scanner 1 is mounted in the scanner holder 23, the user has no need of taking the scanner 1 out from the scanner holder 23. The scanner 1 is operated through the operating holes 236 and the maintaining hole 237 of the scanner holder 23, and the breakdown of the scanner 1 is troubleshooted. In the first preferred embodiment, the base plate 21 and the scanner holder 23 of the bracket 2 are formed in an integral structure. The hollow guiding element 4 is corresponding to the assembling hole 239 of the scanner holder 23. The paper outlet tray 5 is corresponding to the opening groove 231 of the scanner holder 23. The inputting end 11 is exposed out from the upper end of the scanner holder 23. The inputting end 11 is corresponding to the assembling hole 239, and the inputting end 11 is aligned with the assembling hole 239. The inputting end 11 is exposed to the assembling hole 239. The inputting end 11 is corresponding to the guiding element 4 through the assembling hole 239. The outputting end 12 is corresponding to the opening groove 231 of the scanner holder 23, and the outputting end 12 is aligned with the opening groove 231 of the scanner holder 23. The outputting end 12 is exposed to the opening groove 231. The outputting end 12 is corresponding to the paper outlet tray 5 through the opening groove 231.

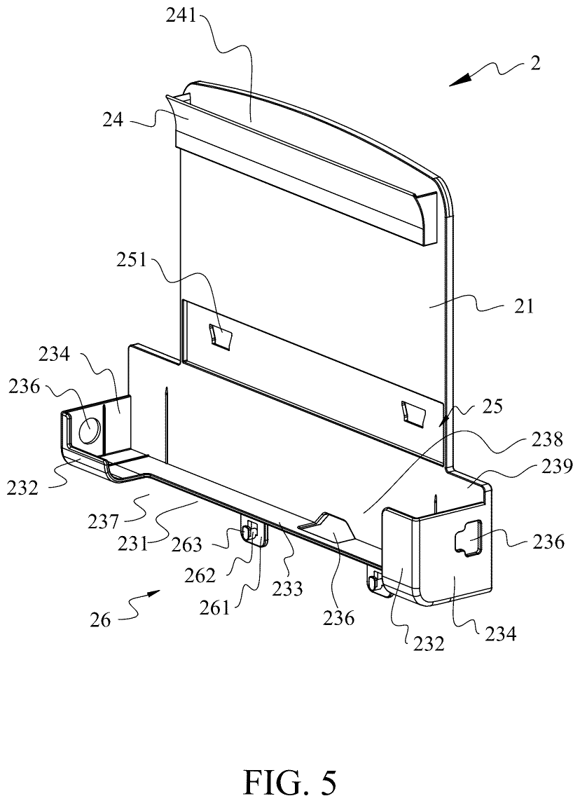

Referring to FIG. 4 and FIG. 5, the feed-in section 24 is disposed at an upper end of the bracket 2. The feed-in section 24 is correspondingly disposed above the guiding element 4. The feed-in section 24 is extended frontward from a front surface of a top end of the base plate 21. A middle of the feed-in section 24 has a feed-in slot 241 vertically penetrating through a top surface and a bottom surface of the feed-in section 24. The feed-in slot 241 guides the document A to move through the feed-in section 24. When the document A passes through the feed-in slot 241, the feed-in section 24 prevents the document A from falling forward. The guiding element 4 is fixed to the bracket 2 by the upper assembly unit 25. An upper end of the guiding element 4 is aligned with the feed-in section 24. A lower end of the guiding element 4 is aligned with the inputting end 11 of the scanner 1. The paper outlet tray 5 is fastened to the lower end of the bracket 2 by the lower assembly unit 26.

Referring to FIG. 1 and FIG. 2, when the scanner 1 scans the document A, the wall mounting device 100 for mounting the scanner 1 is fastened on the object 6, and the scanner 1 is assembled into the scanner holder 23. The user places the document A downward into the feed-in slot 241 of the feed-in section 24, and then the document A passes through a middle of the guiding element 4, and the document A is guided by the guiding element 4 to enter the scanner 1 through the inputting end 11. After the document A is scanned, the scanner 1 ejects the document A outward from the outputting end 12, and the ejected document A falls into the paper outlet tray 5 to complete the scanning process of the document A.

Referring to FIG. 4 to FIG. 8, the upper assembly unit 25 is arranged between the bracket 2 and the guiding element 4 for fastening the guiding element 4 to the bracket 2. The upper assembly unit 25 includes a buckling groove 251 longitudinally penetrating through the base plate 21, and a buckling block 252 extended upward from a bottom wall of the buckling groove 251. The guiding element 4 has a hooking portion 253 extended rearward and then extended downward from a rear surface of the guiding element 4. Specifically, two sides of the rear surface of the guiding element 4 protrude rearward and then extend downward to form two hooking portions 253. The buckling groove 251 is disposed at the bracket 2. The hooking portion 253 is formed in an inverted L shape. The hooking portion 253 is combined with the buckling groove 251 of the upper assembly unit 25. Specifically, the wall mounting device 100 for mounting the scanner 1 includes two upper assembly units 25. Each upper assembly unit 25 includes the buckling groove 251, the buckling block 252 and the hooking portion 253. The hooking portion 253 passes through the buckling groove 251, and the hooking portion 253 hooks the buckling block 252 for fastening the guiding element 4 to the bracket 2.

Referring to FIG. 4 to FIG. 10, a top of a front wall of the guiding element 4 extends upward and is arched rearward to form a blocking wall 41. The blocking wall 41 prevents the document A from falling forward while the document A is in a process of passing through the inputting end 11. The middle of the guiding element 4 has a guiding slot 42 vertically penetrating through a top of the guiding element 4. The guiding slot 42 gradually tapers from top to bottom. A bottom of the guiding slot 42 extends downward to form a through hole 43 penetrating through a bottom of the guiding element 4. The through hole 43 faces towards the scanner holder 23, and the through hole 43 is aligned with the scanner holder 23. A bottom of a front wall of the through hole 43 extends downward to form a front shielding plate 44. A bottom of a rear wall of the through hole 43 extends downward to form a rear shielding plate 45. The front shielding plate 44 is correspondingly mounted to a top of a front end of the inputting end 11. The rear shielding plate 45 is correspondingly mounted to a top of a rear end of the inputting end 11, and the rear shielding plate 45 contacts with a rear wall of the inputting end 11. The through hole 43 is in alignment with a top of the inputting end 11 for guiding the document A into the scanner 1 along the inputting end 11.

The front shielding plate 44 and the rear shielding plate 45 guides the document A enter the inputting end 11 of the scanner 1 successfully. The front shielding plate 44 and the rear shielding plate 45 prevent the document A deviating from the inputting end 11 of the scanner 1. An inner surface of the front shielding plate 44 protrudes inward to form a guiding rib 46 extending from the top to the bottom. Specifically, two portions of the inner surface of the front shielding plate 44 protrude inward to form two guiding ribs 46 extending from the top to the bottom. One side of the rear shielding plate 45 is cut off to form an accommodating slot 47 extending from the top to the bottom. The guiding rib 46 is correspondingly located in front of the accommodating slot 47. The accommodating slot 47 is located behind the two guiding ribs 46. The guiding rib 46 guides the document A. The document A is guided by the two guiding ribs 46, so the document A triggers a sensor (not shown) of the scanner 1 accurately to activate corresponding functions of the scanner 1. The accommodating slot 47 accommodates thicker documents, so that the thicker documents pass through the guiding slot 42 through the accommodating slot 47 to avoid a blockage of the thicker documents in the guiding slot 42. In this first preferred embodiment, the guiding rib 46 and the accommodating slot 47 are aligned in a front-to-rear direction. The two guiding ribs 46 are aligned with the accommodating slot 47 along the front-to-rear direction. The two guiding ribs 46 are corresponding to the accommodating slot 47 along the front-to-rear direction.

Referring to FIG. 4 to FIG. 7, the lower assembly unit 26 is mounted between the bracket 2 and the paper outlet tray 5 to fasten the paper outlet tray 5 with the bracket 2. The paper outlet tray 5 is mounted to the lower end of the scanner holder 23 of the lower end of the bracket 2. The lower assembly unit 26 includes a flat plate-shaped buckling plate 261 extended downwardly from a bottom surface of the scanner holder 23 of the bracket 2, a fastening pillar 262 protruded frontward from a middle of a front surface of the buckling plate 261, a blocking element 263 extended upward from a top of a front end of the fastening pillar 262, a buckling piece 264 extended upward from a top edge of the paper outlet tray 5 and combined with the fastening pillar 262, and a buckling hole 265 longitudinally penetrating through the buckling piece 264.

Specifically, the wall mounting device 100 for mounting the scanner 1 includes two lower assembly units 26. Each lower assembly unit 26 includes the buckling plate 261, the fastening pillar 262, the blocking element 263, the buckling piece 264 and the buckling hole 265. The buckling piece 264 is buckled to a front surface of the buckling plate 261. The fastening pillar 262 passes through the buckling hole 265. The blocking element 263 is located in front of the buckling piece 264. A rear surface of the blocking element 263 is blocked by a front surface of the buckling piece 264 to prevent the paper outlet tray 5 moving frontward to break away from the bracket 2. An inside of a lower end of the paper outlet tray 5 is hollow to form a holding space 51 penetrating through a top surface of the lower end of the paper outlet tray 5. A top of the holding space 51 faces the outputting end 12 of the scanner 1. The holding space 51 accommodates the document A which is fed out from the outputting end 12.

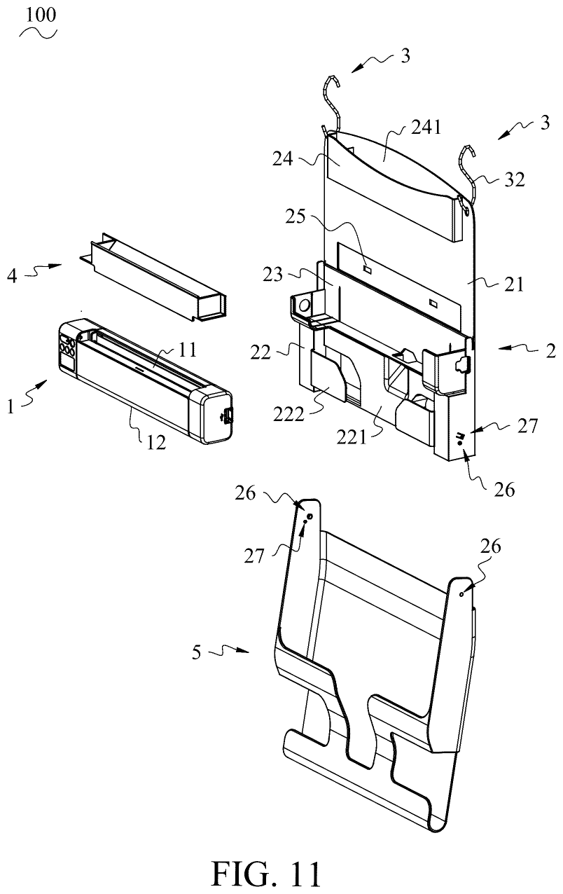

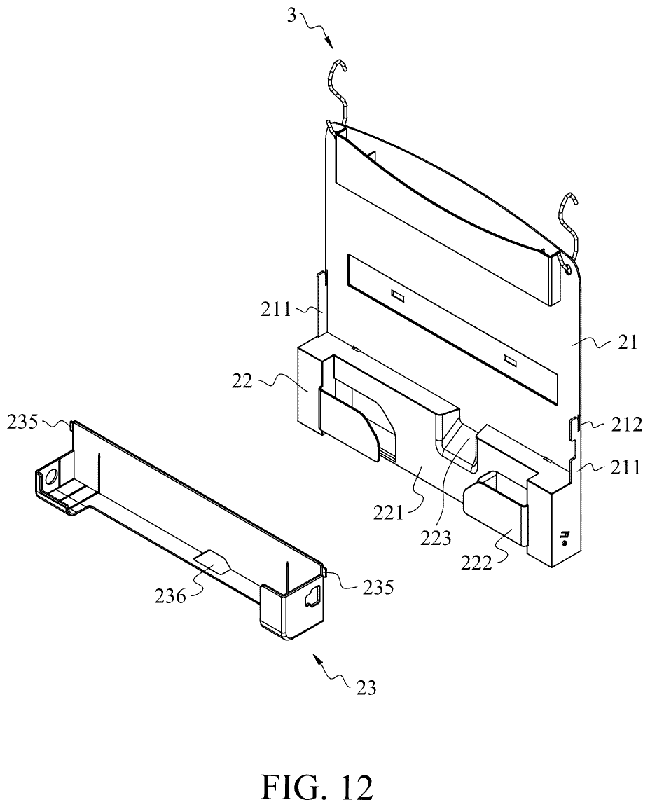

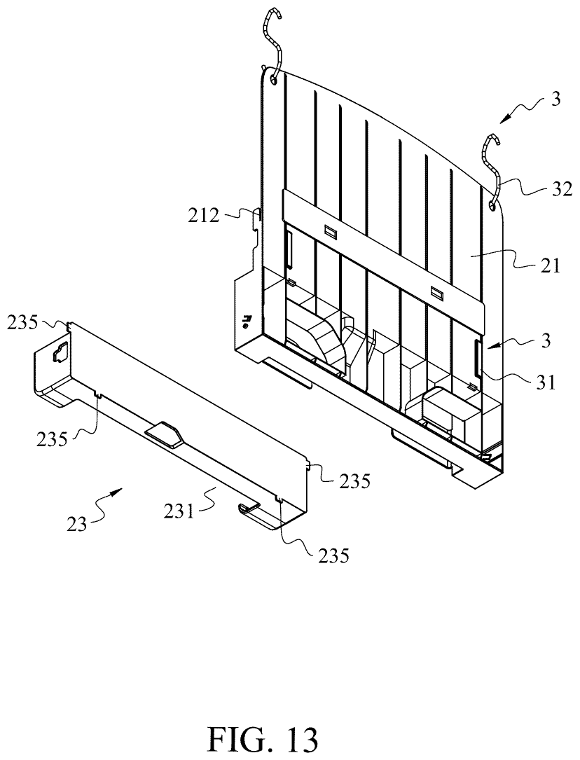

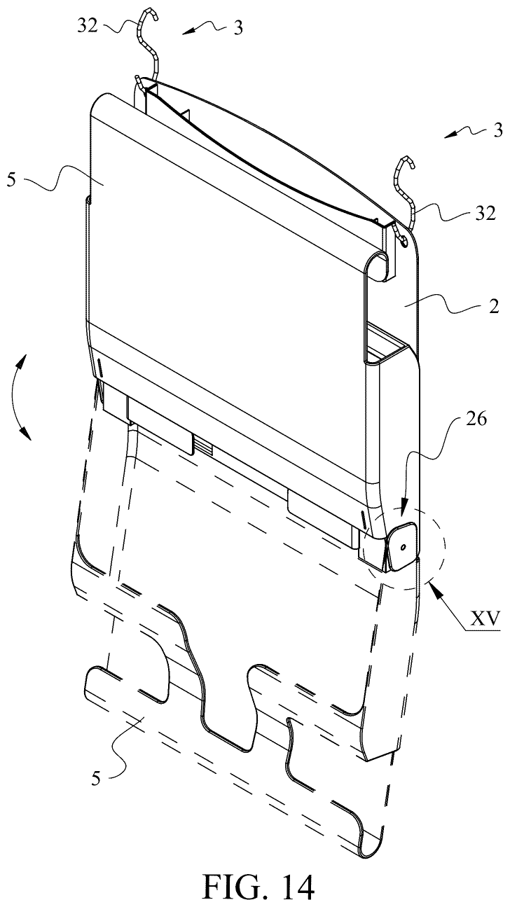

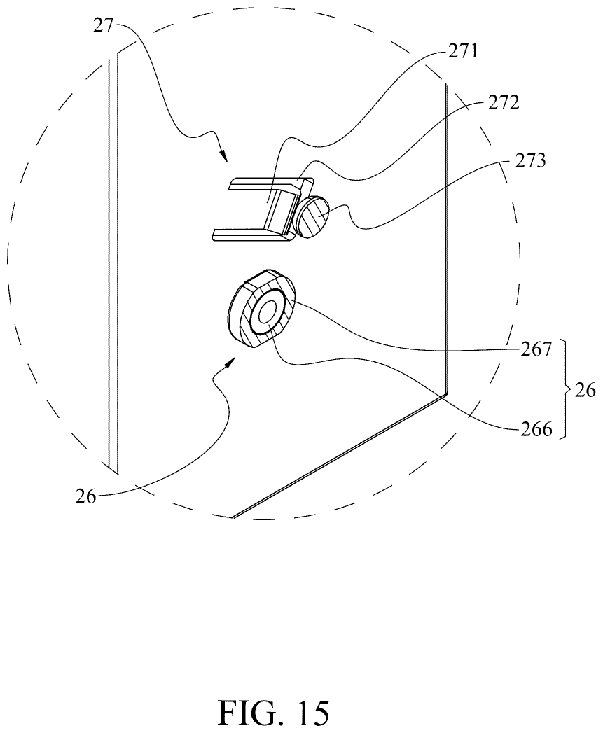

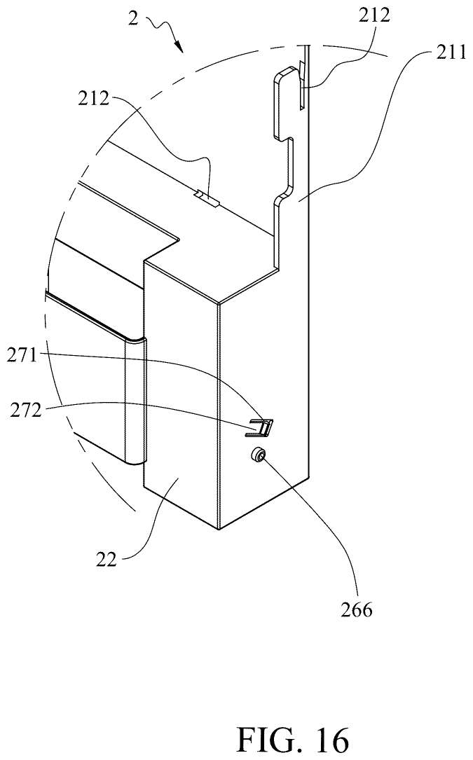

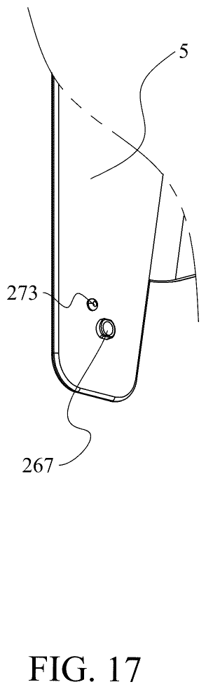

Referring to FIG. 10 to FIG. 17, in the second preferred embodiment, the bracket 2 further includes a bottom plate 22 extended downward and protruded frontward from a bottom of the base plate 21 for supporting the scanner holder 23. The scanner holder 23 is detachably mounted to the bracket 2, and the scanner holder 23 is disposed at an upper end of the bottom plate 22. A middle of a lower end of a front surface of the bottom plate 22 is recessed inward and then oppositely extend transversely to form an internal channel 221. The document A passes through the internal channel 221. A top end of the internal channel 221 is corresponding to the opening groove 231 of the scanner holder 23. A bottom end of the internal channel 221 is corresponding to the holding space 51 of the paper outlet tray 5. An upper end of the internal channel 221 is aligned with the opening groove 231. A lower end of the internal channel 221 is aligned with the holding space 51. The lower end of the front surface of the bottom plate 22 is connected with a protecting slice 222. Two sides of the lower end of the front surface of the bottom plate 22 protrude frontward and then are bent inward to form two protecting slices 222 blocking a front of the internal channel 221. The two protecting slices 222 guide the document A which pass through the internal channel 221 to be received in the holding space 51. Two lower ends of two sides of the base plate 21 perpendicularly protrude frontward to form two side plates 211 disposed on the upper end of the bottom plate 22. The scanner holder 23 is arranged between the two side plates 211.

Referring to FIG. 10 to FIG. 17, the scanner holder 23 includes a mounting rib 235 which is extended outward from one edge of a rear surface of the scanner holder 23. The bracket 2 has a mounting slot 212 corresponding to the mounting rib 235. The mounting rib 235 is inserted into the mounting slot 212. Specifically, the scanner holder 23 has a plurality of the mounting ribs 235. Several portions of two side edges and a bottom edge of the rear surface of the scanner holder 23 protrude outward to form the plurality of the mounting ribs 235. The bracket 2 has a plurality of the mounting slots 212. Two tops of two rear ends of the two side plates 211, and two sides of a junction between the base plate 21 and the bottom plate 22 are recessed downward to form the plurality of the mounting slots 212. The plurality of the mounting ribs 235 are corresponding to the plurality of the mounting slots 212, and the plurality of the mounting ribs 235 are detachably mounted in the plurality of the mounting slots 212, so the scanner holder 23 is detachably mounted to the bracket 2. A middle of a top surface of the upper end of the bottom plate 22 is recessed downward to form a mounting opening 223. The mounting opening 223 is corresponding to an operating component (not shown) of the scanner 1. In the second preferred embodiment, the operating component is a memory card slot, and a memory card (not shown) is able to be mounted into the scanner 1 or be removed from the scanner 1 through the mounting opening 223.

Referring to FIG. 10 to FIG. 17 again, in the second preferred embodiment, the two lower assembly units 26 according to the first preferred embodiment are different from the two lower assembly units 26 according to the second preferred embodiment. In the second preferred embodiment, two sides of an upper end of the paper outlet tray 5 are pivotally connected to two sides of the lower end of the bracket 2, and the two lower assembly units 26 are pivotally connected between the bracket 2 and the paper outlet tray 5, the paper outlet tray 5 is rotatable with respect to the bracket 2, and the paper outlet tray 5 is foldable with respect to the bracket 2, so that a size of the wall mounting device 100 for mounting the scanner 1 is reduced to facilitate a storage. The paper outlet tray 5 is connected to the bracket 2 via the two lower assembly units 26. Each lower assembly unit 26 includes a pivoting section 266, and a pivoting sleeve 267 matched with the pivoting section 266. The pivoting sleeve 267 is combined with the pivoting section 266. Specifically, the two lower assembly units 26 includes two pivoting sections 266 and two pivoting sleeves 267. The two pivoting sections 266 are extended outward from two side surfaces of the bracket 2. The two pivoting sleeves 267 are protruded inward from two inner surfaces of two sides of the paper outlet tray 5. The two pivoting sleeves 267 are sleeved around the two pivoting sections 266, so the paper outlet tray 5 is fastened to the bracket 2.

Each lower assembly unit 26 further includes a movable section 27 for adjusting a folded position of the paper outlet tray 5. The movable section 27 includes a limiting groove 271, a flexible hook 272 and a protrusion 273. Specifically, the two lower assembly units 26 include two movable sections 27. The two movable sections 27 include two limiting grooves 271, two flexible hooks 272 and two protrusions 273. Two lower portions of two outer side surfaces of the bottom plate 22 are recessed inward to form the two limiting grooves 271. The two limiting grooves 271 slantwise extend rearward and downward. Two front inner walls of the two limiting grooves 271 extend towards two rear inner walls of the two limiting grooves 271 and then protrude outward to form the two flexible hooks 272. The two flexible hooks 272 are received in the two limiting grooves 271. The two flexible hooks 272 slantwise extend rearward and downward. Two lower ends of two facing surfaces of the two sides of the paper outlet tray 5 protrude inward to form the two protrusions 273.

The user is able to regard the pivoting section 266 and the pivoting sleeve 267 which are combined as a rotation center to rotate the paper outlet tray 5 towards a direction which is away from the object 6, so that the paper outlet tray 5 rotates to be folded or unfolded with respect to the bracket 2. At the moment, the two protrusions 273 pass along the two flexible hooks 272 in a rotational direction of the paper outlet tray 5, and the two flexible hooks 272 are retracted into the two limiting grooves 271, so the two protrusions 273 break through interferences between the two protrusions 273 and the two flexible hooks 272 to pass along the two flexible hooks 272, then the two flexible hooks 272 spring back to return to original positions, and the two protrusions 273 are blocked by rear ends of the two flexible hooks 272, so that the paper outlet tray 5 abuts against the bracket 2, and the paper outlet tray 5 and the bracket 2 keep remaining a folded status.

As described above, the scanner 1 is used for scanning the document A, the wall mounting device 100 for mounting the scanner 1 includes the bracket 2 which has the scanner holder 23, the fastening element 3 fastened to the bracket 2, and the guiding element 4 and the paper outlet tray 5 combined with the bracket 2. Furthermore, the guiding element 4 is mounted at the upper end of the scanner holder 23 and the guiding element 4 is aligned with the inputting end 11 of the scanner 1, the paper outlet tray 5 is mounted at the lower end of the bracket 2 and the paper outlet tray 5 is aligned with the outputting end 12 of the scanner 1, and the outputting end 12 is disposed corresponding to the opening groove 231 of the scanner holder 23. In addition, the paper outlet tray 5 is able to be rotated and folded with respect to the bracket 2 for maintaining the folded status and saving a space. Thus, the scanner 1 is received in the scanner holder 23 by the wall mounting device 100 for mounting the scanner 1, the bracket 2 of the wall mounting device 100 for mounting the scanner 1 is fastened on the object 6 which is the wall or the office partition via the fastening element 3 to proceed with the scanning, and the space-saving wall mounting device 100 for mounting the scanner 1 is provided to effectively solve a dilemma of an insufficient desktop space.

What is claimed is:

1. A wall mounting device for mounting a scanner, the wall mounting device for mounting the scanner being fastened to an object, the object being made of a ferromagnetic material, a top end and a bottom end of the scanner defining an inputting end and an outputting end, respectively, the wall mounting device for mounting the scanner comprising:
a bracket, a lower end of the bracket having a scanner holder, the scanner holder having a bottom wall, two front walls bent upward from two sides of a front of the bottom wall, and two side walls bent upward from two opposite sides of the bottom wall, the two front walls, the bottom wall and the two side walls surrounding a mounting space, an upper end of the scanner holder being opened freely to form an assembling hole connected with the mounting space, the scanner being inserted into the mounting space from the assembling hole, a lower end of the scanner holder defining an opening groove, and the opening groove penetrating through a front end of the bottom wall, the inputting end being corresponding to the assembling hole, the inputting end being exposed to the assembling hole, the outputting end being corresponding to the opening groove, the outputting end being exposed to the opening groove;
a fastening element fastened to a rear surface of the bracket, the fastening element including a magnetic part, the magnetic part being arranged at the rear surface of the bracket, the object being mutually attracted with the magnetic part, so the scanner holder of the bracket together with the scanner being fastened to the object;
a hollow guiding element mounted to the upper end of the scanner holder of the bracket, the guiding element being corresponding to the assembling hole of the scanner holder, the inputting end being corresponding to the guiding element through the assembling hole; and
a paper outlet tray mounted to the lower end of the bracket, the paper outlet tray being corresponding to the opening groove of the scanner holder, the outputting end being corresponding to the paper outlet tray through the opening groove.

2. The wall mounting device for mounting the scanner as claimed in claim 1, wherein at least one of the two side walls and the bottom wall of the scanner holder has an operating hole penetrating through the at least one of the two side walls and the bottom wall of the scanner holder.

3. The wall mounting device for mounting the scanner as claimed in claim 1, wherein the scanner holder having a maintaining hole between the two front walls, the maintaining hole is corresponding to a movable cover of the scanner.

4. The wall mounting device for mounting the scanner as claimed in claim 1, wherein the bracket includes a hollow feed-in section, the feed-in section is disposed at an upper end of the bracket, the feed-in section is correspondingly disposed above the guiding element.

5. The wall mounting device for mounting the scanner as claimed in claim 1, wherein a top of a front wall of the guiding element extends upward and is arched rearward to form a blocking wall, a middle of the guiding element has a guiding slot vertically penetrating through a top of the guiding element, the guiding slot gradually tapers from top to bottom, a bottom of the guiding slot extends downward to form a through hole penetrating through a bottom of the guiding element, the through hole faces towards the scanner holder, the through hole is in alignment with a top of the inputting end.

6. The wall mounting device for mounting the scanner as claimed in claim 5, wherein a bottom of a front wall of the through hole extends downward to form a front shielding plate, a bottom of a rear wall of the through hole extends downward to form a rear shielding plate, the front shielding plate is correspondingly mounted to a top of a front end of the inputting end, the rear shielding plate is correspondingly mounted to a top of a rear end of the inputting end, and the rear shielding plate contacts with a rear wall of the inputting end.

7. The wall mounting device for mounting the scanner as claimed in claim 6, wherein an inner surface of the front shielding plate protrudes inward to form a guiding rib extending from the top to the bottom, one side of the rear shielding plate is cut off to form an accommodating slot extending from the top to the bottom, the guiding rib is correspondingly located in front of the accommodating slot.

8. The wall mounting device for mounting the scanner as claimed in claim 1, further comprising an upper assembly unit arranged between the bracket and the guiding element, the bracket including a base plate, the upper assembly unit including a buckling groove longitudinally penetrating through the base plate, and a buckling block extended upward from a bottom wall of the buckling groove, the guiding element having a hooking portion extended rearward and then extended downward from a rear surface of the guiding element, the hooking portion being formed in an inverted L shape, the hooking portion being combined with the buckling groove, the hooking portion hooking the buckling block.

9. The wall mounting device for mounting the scanner as claimed in claim 1, further comprising a lower assembly unit mounted between the bracket and the paper outlet tray, the lower assembly unit including a buckling plate extended downwardly from a bottom surface of the scanner holder, a fastening pillar protruded frontward from a middle of a front surface of the buckling plate, a blocking element extended upward from a top of a front end of the fastening pillar, a buckling piece extended upward from a top edge of the paper outlet tray and combined with the fastening pillar, and a buckling hole longitudinally penetrating through the buckling piece, the fastening pillar passing through the buckling hole, a rear surface of the blocking element being blocked by a front surface of the buckling piece.

10. The wall mounting device for mounting the scanner as claimed in claim 1, wherein the bracket includes a base plate, and a bottom plate extended downward and protruded frontward from a bottom of the base plate, the scanner holder is detachably mounted to the bracket, and the scanner holder is disposed at an upper end of the bottom plate, an inside of a lower end of the paper outlet tray is hollow to form a holding space penetrating through a top surface of the lower end of the paper outlet tray, a top of the holding space faces the outputting end, a middle of a lower end of a front surface of the bottom plate is recessed inward and then oppositely extend transversely to form an internal channel, a top end of the internal channel is corresponding to the opening groove, a bottom end of the internal channel is corresponding to the holding space of the paper outlet tray, two sides of the lower end of the front surface of the bottom plate protrude frontward and then are bent inward to form two protecting slices blocking a front of the internal channel.

11. The wall mounting device for mounting the scanner as claimed in claim 10, wherein two lower ends of two sides of the base plate perpendicularly protrude frontward to form two side plates disposed on the upper end of the bottom plate, the scanner holder is arranged between the two side plates, several portions of two side edges and a bottom edge of a rear surface of the scanner holder protrude outward to form a plurality of mounting ribs, two tops of two rear ends of the two side plates, and two sides of a junction between the base plate and the bottom plate are recessed downward to form a plurality of mounting slots, the plurality of the mounting ribs are detachably mounted in the plurality of the mounting slots.

12. The wall mounting device for mounting the scanner as claimed in claim 10, wherein a middle of a top surface of the upper end of the bottom plate is recessed downward to form a mounting opening.

13. The wall mounting device for mounting the scanner as claimed in claim 1, further comprising two lower assembly units pivotally connected between the bracket and the paper outlet tray, each lower assembly unit including a pivoting section, and a pivoting sleeve matched with the pivoting section, the pivoting sleeve being combined with the pivoting section, the two lower assembly units including two pivoting sections and two pivoting sleeves, the two pivoting sections being extended outward from two side surfaces of the bracket, the two pivoting sleeves being protruded inward from two inner surfaces of two sides of the paper outlet tray, the two pivoting sleeves being sleeved around the two pivoting sections.

14. The wall mounting device for mounting the scanner as claimed in claim 13, wherein the paper outlet tray is rotatable with respect to the bracket, and the paper outlet tray is foldable with respect to the bracket, the two lower assembly units include two movable sections, the two movable sections include two limiting grooves, two flexible hooks and two protrusions, two lower portions of two outer side surfaces of the bottom plate are recessed inward to form the two limiting grooves, two front inner walls of the two limiting grooves extend towards two rear inner walls of the two limiting grooves and then protrude outward to form the two flexible hooks, the two flexible hooks are received in the two limiting grooves, two lower ends of two facing surfaces of the two sides of the paper outlet tray protrude inward to form the two protrusions, the two protrusions pass along the two flexible hooks in a rotational direction of the paper outlet tray, and the two flexible hooks are retracted into the two limiting grooves, so the two protrusions break through interferences between the two protrusions and the two flexible hooks to pass along the two flexible hooks, then the two flexible hooks spring back to return to original positions, and the two protrusions are blocked by rear ends of the two flexible hooks.

15. The wall mounting device for mounting the scanner as claimed in claim 1, wherein the fastening element includes a S-shaped locking hook, the locking hook penetrates through an upper end of the bracket.

16. The wall mounting device for mounting the scanner as claimed in claim 1, wherein the scanner holder is detachably mounted to the bracket, the scanner holder includes a mounting rib which is extended outward from one edge of a rear surface of the scanner holder, the bracket has a mounting slot corresponding to the mounting rib, the mounting rib is inserted into the mounting slot.

17. A wall mounting device for mounting a scanner, the wall mounting device for mounting the scanner being fastened to an object, a top end and a bottom end of the scanner defining an inputting end and an outputting end, respectively, the wall mounting device for mounting the scanner comprising:
a bracket, a lower end of the bracket having a scanner holder, the scanner holder having a bottom wall, a front wall bent upward from a front of the bottom wall, and two side walls bent upward from two opposite sides of the bottom wall, the front wall, the bottom wall and the two side walls surrounding a mounting space, an upper end of the scanner holder being opened freely to form an assembling hole connected with the mounting space, the scanner being inserted into the mounting space from the assembling hole, a lower end of the scanner holder defining an opening groove, and the opening groove penetrating through the bottom wall, the inputting end being corresponding to the assembling hole, the inputting end being exposed to the assembling hole, the outputting end being corresponding to the opening groove, the outputting end being exposed to the opening groove;
a fastening element mounted to the bracket for fastening the bracket to the object;
a guiding element mounted to the upper end of the scanner holder of the bracket, the guiding element being corresponding to the assembling hole of the scanner holder, the inputting end being corresponding to the guiding element through the assembling hole; and
a paper outlet tray mounted to the lower end of the bracket, the paper outlet tray being corresponding to the opening groove of the scanner holder, the outputting end being corresponding to the paper outlet tray through the opening groove,
wherein two sides of an upper end of the paper outlet tray are pivotally connected to two sides of the lower end of the bracket, the paper outlet tray is rotatable with respect to the bracket, and the paper outlet tray is foldable with respect to the bracket.

18. The wall mounting device for mounting the scanner as claimed in claim 17, further comprising two lower assembly units pivotally connected between the bracket and the paper outlet tray, the two lower assembly units including two pivoting sections and two pivoting sleeves, the two pivoting sections being extended outward from two side surfaces of the bracket, the two pivoting sleeves being protruded inward from two inner surfaces of two sides of the paper outlet tray, the two pivoting sleeves being sleeved around the two pivoting sections.

19. The wall mounting device for mounting the scanner as claimed in claim 18, wherein the two lower assembly units include two movable sections, the two movable sections include two limiting grooves, two flexible hooks and two protrusions, the bracket includes a base plate, and a bottom plate extended downward and protruded frontward from a bottom of the base plate, two lower portions of two outer side surfaces of the bottom plate are recessed inward to form the two limiting grooves, two front inner walls of the two limiting grooves extend towards two rear inner walls of the two limiting grooves and then protrude outward to form the two flexible hooks, the two flexible hooks are received in the two limiting grooves, two lower ends of two facing surfaces of the two sides of the paper outlet tray protrude inward to form the two protrusions, the two protrusions pass along the two flexible hooks in a rotational direction of the paper outlet tray, and the two flexible hooks are retracted into the two limiting grooves, so the two protrusions break through interferences between the two protrusions and the two flexible hooks to pass along the two flexible hooks, then the two flexible hooks spring back to return to original positions, and the two protrusions are blocked by rear ends of the two flexible hooks.

20. A wall mounting device for mounting a scanner, the wall mounting device for mounting the scanner being fastened to an object, a top end and a bottom end of the scanner defining an inputting end and an outputting end, respectively, the wall mounting device for mounting the scanner comprising:
a bracket, a lower end of the bracket having a scanner holder, the scanner holder being detachably mounted to the bracket, the scanner holder having a mounting space formed therein, an upper end of the scanner holder being opened freely to form an assembling hole connected with the mounting space, the scanner being inserted into the mounting space from the assembling hole, a lower end of the scanner holder defining an opening groove, and the opening groove connected with the mounting space, the inputting end being corresponding to the assembling hole, the inputting end being exposed to the assembling hole, the outputting end being corresponding to the opening groove, the outputting end being exposed to the opening groove;
a fastening element mounted to the bracket for fastening the bracket to the object;
a guiding element mounted to the upper end of the scanner holder of the bracket, the guiding element being corresponding to the assembling hole of the scanner holder, the inputting end being corresponding to the guiding element through the assembling hole, a middle of the guiding element having a guiding slot vertically penetrating through a top and a bottom of the guiding element, a guiding rib extending from one inner surface of the guiding slot, the other inner surface of the guiding slot being cut off to form an accommodating slot; and
a paper outlet tray mounted to the lower end of the bracket, the paper outlet tray being corresponding to the opening groove of the scanner holder, the outputting end being corresponding to the paper outlet tray through the opening groove.
